(19) United States
(12) Patent Application Publication
(10) Pub. No.: US 2006/0214049 A1
(43) Pub. Date: Sep. 28, 2006

(54) Non-round profiled pultruded tube

(75) Inventor: Ismael A. Hernandez, Florence, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/087,192

(22) Filed: Mar. 23, 2005

(51) Int. Cl. B65H 75/18; B31C 11/00

(52) U.S. Cl. 242/610.1; 493/273; 493/293; 493/299; 242/610.4; 242/610.6

(57) ABSTRACT

A tubular article is formed of a spirally wound tube of paperboard. The paperboard tube has a circular cross-section at both its inner and outer surfaces. A shell of resin is pultruded onto the outer surface of the tube. Various resins can be used, including polyesters, vinyl esters, thermosetting epoxy resins, and others. The shell can optionally include reinforcing fibers, which can be short fibers or substantially continuous fibers oriented in various orientations relative to the paperboard tube. The reinforcing fibers can be in the form of rovings or fiber mats or woven fabrics. The shell's inner surface conforms to the circular outer surface of the tube and is intimately bonded thereto. The outer surface of the shell is defined by the pultrusion die to be non-circular in cross-section. Various non-circular shapes can be provided at the outer surface of the shell.

### BACKGROUND OF THE INVENTION

The invention relates to tubular articles in general, and relates particularly to winding cores for materials such as paper, plastic film, foil, sheet metal, and the like.

A spirally wound tube usually is formed by winding one or more strips or plies of flexible material such as paperboard about a circular cylindrical mandrel that is stationary. In the case of a single-ply tube, the edges of the ply are overlapped and adhered together with a suitable adhesive; in the case of a multi-ply tube, the edges of adjacent plies are axially staggered relative to one another and the plies are adhered together. A winding belt engages the tube formed on the mandrel and advances the tube along the mandrel in screw fashion.

Spirally wound tubes are used in a variety of applications, and particularly are used as winding cores. Winding cores made by the spiral winding process are constrained to be circular in cross-section because the core is advanced along the mandrel in screw fashion, which would be impossible if the mandrel were non-circular.

Advantages could be attained if a winding core could be made to have a non-circular cross-sectional shape at its outer surface. At the same time, the inner surface desirably is circular because winding and unwinding equipment in common use is designed for conventional circular cores. Therefore, the sought-after winding core with non-circular outer surface cannot be provided by forming the core about a non-circular mandrel, as is sometimes done in the manufacture of non-round container bodies using a convolute wrapping process, because then the inner surface of the core would be non-circular. Additionally, convolute wrapping is much slower than spiral winding.

Tubular articles can be extruded from plastic materials in many different cross-sectional shapes. In the case of a winding core, which generally has a relatively thick wall (e.g., 0.3 to 0.7 inch or more) and can range from 3 to 22 inches in inside diameter, a considerable amount of plastic material would be necessary to make an all-plastic core. For the types of high-strength plastics that would be needed for a winding core, which are relatively expensive, the all-plastic construction would not be able to effectively compete with paperboard cores on a cost basis.

### BRIEF SUMMARY OF THE INVENTION

The invention addresses the above needs and achieves other advantages by providing a tubular article that is formed of a spirally wound tube of paperboard. The paperboard tube has a circular cross-section at both its inner and outer surfaces. A shell of resin is pultruded onto the outer surface of the tube. Various resins can be used, including polyesters, vinyl esters, thermosetting epoxy resins, and others. The shell can optionally include reinforcing fibers, which can be short fibers or substantially continuous fibers oriented in various orientations relative to the paperboard tube. The reinforcing fibers can be in the form of rovings or fiber mats or woven fabrics. The shell's inner surface conforms to the circular outer surface of the tube and is intimately bonded thereto. The outer surface of the shell is defined by the pultrusion die to be non-circular in cross-section. Various non-circular shapes can be provided at the outer surface of the shell.

For instance, in one embodiment of the invention comprising a winding core, the outer surface of the shell defines at least one longitudinally extending groove. As an example, a single groove can extend the length of the core for receiving the end of a web material to be wound about the core. As a result, the end of the web material does not form a bump that normally would propagate out to other layers of the wound material and possibly leave undesirable marks in the material.

In another embodiment, the outer surface of the shell defines a plurality of longitudinally extending grooves that are circumferentially spaced apart. The grooves, for example, could provide a surface for anchoring devices, could contain chemicals for performance enhancement, or could be useful in transporting moisture away from the wound product.

A further embodiment of the invention comprises a tubular article wherein the outer surface of the shell is polygonal in cross-section, or generally oval in cross-section. These types of shapes can provide enhanced strength to the tubular article.

In some embodiments of the invention, the resin shell has a smaller radial thickness, on an average basis about the circumference of the tubular article, than that of the paperboard tube. Preferably, the shell at its minimum thickness location(s) is only thick enough to cover the paperboard tube surface and maintain continuity of the resin material about the circumference.

In other embodiments, the average thickness of the shell can be substantially equal to or greater than that of the paperboard tube.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic perspective view of an apparatus and process for making a tubular article in accordance with one embodiment of the invention;

FIG. 2 is a cross-sectional view along line 2-2 in FIG. 1;

FIG. 3 is a perspective view of a tubular article having a longitudinal groove in accordance with one embodiment of the invention;

FIG. 4 is a cross-sectional view along line 4-4 in FIG. 3;

FIG. 5 is a cross-sectional view showing another embodiment of the invention;

FIG. 6 is a cross-sectional view of a further embodiment of the invention; and

FIG. 7 is a schematic illustration of a process and apparatus for making a tubular article in accordance with another embodiment of the invention.

### DETAILED DESCRIPTION OF THE INVENTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

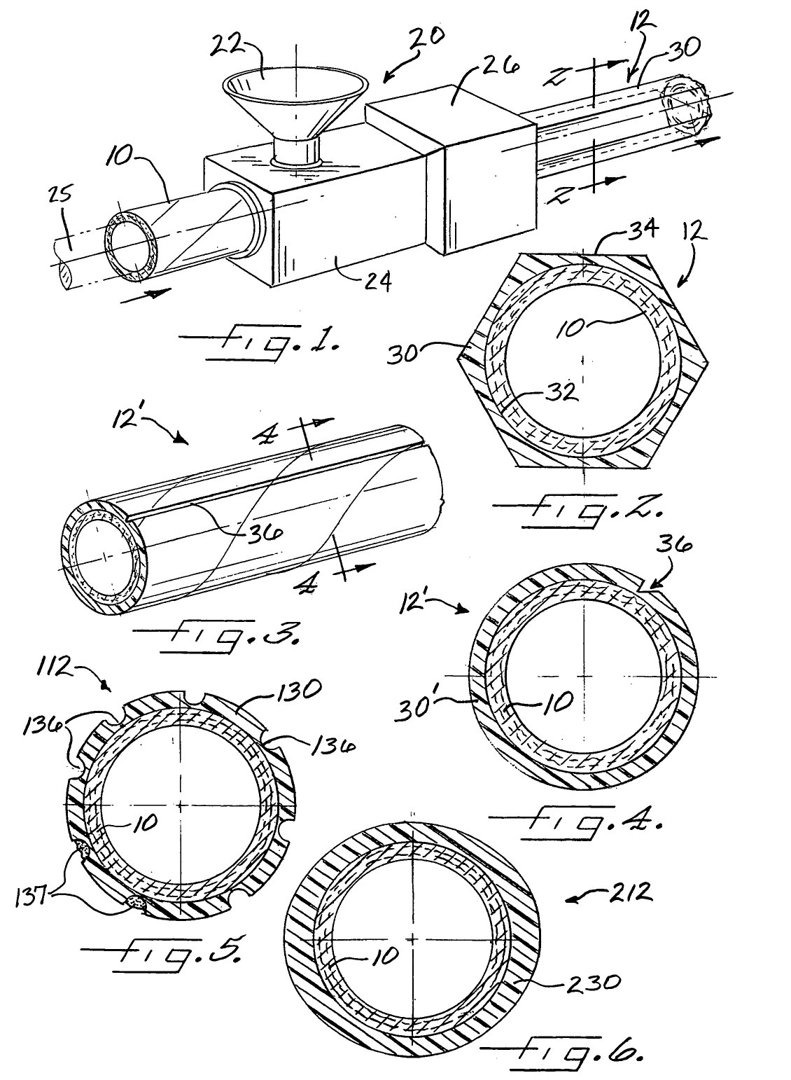

An apparatus and a process for making tubular articles in accordance with the invention are illustrated in FIG. 1. The process entails passing a pre-manufactured spirally wound paperboard tube 10 through a pultrusion device 20. In general, a paperboard tube comprises a plurality of paperboard plies helically wound about an axis one atop another and adhered together. The construction of the starting paperboard tube 10 is not illustrated, as the manufacture of spirally wound paperboard tubes is well known in the art and need not be described in detail herein.

The pultrusion device 20 is depicted in schematic fashion, but generally includes an infeed hopper or inlet 22 that receives plasticized polymer matrix material and feeds the material into an annular chamber 24 that surrounds the paperboard tube 10 as the tube is advanced axially through the chamber. A cylindrical center plug or mandrel 25 optionally can be included as a guide for the tube, the mandrel 25 having an outer diameter slightly smaller than the inside diameter of the tube 10. A die 26 surrounds the tube 10 and receives the plasticized matrix material along with the tube. The die is shaped to impart a non-circular profile to the shell 30 of matrix material that covers and is bonded to the outer surface of the tube 10. The pultrusion apparatus also includes a cooling chamber or the like (not shown) for cooling and curing the resin shell. The resulting non-circular tube 12 exits the pultrusion apparatus with the aid of rollers (not shown) or the like, which frictionally engage the tube 12 and pull the tube linearly in the direction of the tube's longitudinal axis. A cutting device (not shown) cuts the tube into desired lengths.

Various matrix materials or resins can be used for the shell 30, including but not limited to polyesters, vinyl esters, or thermosetting epoxy resins. These resins could be further modified by the use of pigments, UV stabilizers, and other chemicals to enhance the resin's characteristics for a particular application, such as resistance to chemical attack.

It will be appreciated that the radially inner surface 32 of the resin shell 30 is circular in cross-section, since it conforms to the circular outer surface of the paperboard tube 10. However, the outer surface 34 of the shell is non-circular in cross-section. Various non-circular cross-sectional shapes can be provided by suitably configuring the die 26 of the pultrusion apparatus. In FIGS. 1 and 2, a polygonal shell 30 is shown. In this particular embodiment, the outer surface 34 of the shell has six sides of equal length, such that the shell is hexagonal. The shell has a minimum radial thickness at the midpoint of each of the six sides, and a maximum thickness at the vertices of the hexagonal shell. Other polygonal shapes can be provided instead of hexagonal. Relative to a circular tube using the same total volume of resin in its shell, a non-circular tube such as the hexagonal tube of FIG. 2 would have greater mechanical strength because of the thickened regions of the shell at the vertices, which function like beams. As a result, in the case of a winding core having a polygonal cross-section, for instance, the core could be used to wind product at higher speeds than an equivalent circular core, and the core would have increased loading capacity relative to the circular core.

A further advantage of a polygonal tube over an equivalent circular tube (i.e., a tube whose wall has the same total volume) is that a plurality of the polygonal tubes can be packed in a denser array than can the circular tubes.

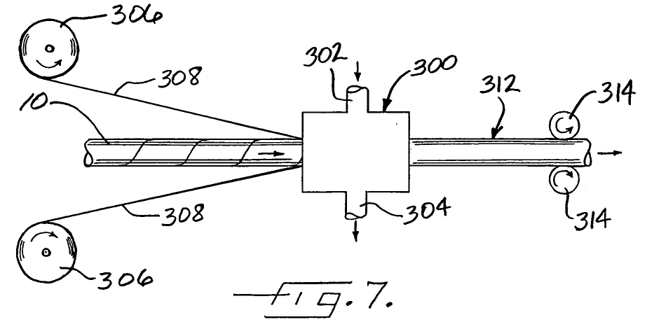

As noted, other cross-sectional shapes can be provided to achieve other objectives. For example, the tube 12′ of FIGS. 3 and 4 includes a circular paperboard tube 10 and a shell 30′ that defines a longitudinal groove 36 that runs parallel to the tube axis and extends the length of the tube. The groove 36 can receive the end of a web material wound onto the tube. With a conventional circular winding core, the end of the web material causes a bump for the subsequent layers of web material, and the disturbance to the web material caused by this bump can propagate radially outward to a substantial number of layers. As a result, in some cases these layers are marred or marked to an extent that can render them unsatisfactory for the intended usage of the web material. This can lead to substantial waste. However, with a core such as in FIGS. 3 and 4, the end of the web material can fit into the groove 36 so that it does not cause a bump.

In other cases, it may be desirable to have a plurality of grooves in the outer surface of a winding core. FIG. 5 shows a core 112 comprising a paperboard tube 10 and an outer shell 130. The shell defines a plurality of circumferentially spaced grooves 136 that extend longitudinally along the core. It could be desirable, for example, to provide the ability for the product wound on the core to “breathe”. With conventional cores, the intimate contact between the smooth surface of the core and the wound material makes it difficult to achieve this. As a result of the longitudinal grooves 136 along the core, air can circulate between the core and the product wound on the core.

Another aspect of the invention, as depicted in FIG. 5, entails the deposition of a chemical 137 in the grooves 136. The chemical could interact with the environment or the wound product to preserve or change the properties of the core. As an example, a desiccant chemical could be included in the grooves to avoid excessive moisture intake of the product wound on the tube. On the other hand, a reactive chemical could be deposited in the grooves to interact with the product and change its strength, color, or other property.

Yet another embodiment of a pultruded tube in accordance with the invention is shown in FIG. 6. The tube 212 comprises a paperboard tube 10 and a shell 230 having an oval or elliptical cross-section. As with the polygonal tube that was previously described, the thickened regions of the shell 230 function as beams to impart enhanced stiffness and strength to the tube.

As already noted, the resin shell of a tube in accordance with the invention can be reinforced with fibers. Various fibers can be used, including glass, aramid (e.g., KEVLAR®), carbon, natural fibers, and others. The fibers can be incorporated in various ways and in various forms. In some cases, short chopped fibers can be included in the resin matrix material. In other cases, much longer fibers can be incorporated into the resin shell. FIG. 7 shows an example of a process and apparatus for making a pultruded tube in accordance with another embodiment of the invention, wherein substantially continuous reinforcing fibers are included in the resin shell. A paperboard tube 10 is longitudinally advanced through a chamber 300 that surrounds the outer surface of the tube. The chamber defines a receptacle for fluid resin material supplied through an inlet 302. There may also be an outlet 304 for resin material, the resin material being continuously circulated through the chamber 300. The chamber also includes the pultrusion die (not shown) for shaping the resin shell about the paperboard tube, as well as a cooling device for cooling and curing the resin shell.

To incorporate reinforcing fibers in the shell, the apparatus includes one or more creels 306 of fiber material in continuous form. The creels can hold fiber roving, fiber mat, woven fabric, or the like. The fiber material 308 is drawn from the creels and pulled, along with the paperboard tube 10, through the chamber 300. The fiber material is impregnated or coated with the fluid resin material as it passes through the chamber. The fiber material then is pulled through the pultrusion die, which shapes the fiber-reinforced resin shell. After the shell is cooled and at least partially cured, the resulting tube 312 exits the chamber, being advanced by friction rollers 314 or the like. A cutting device (not shown) cuts the tube into desired lengths.

The fiber material 308 in FIG. 7 is shown being advanced longitudinally such that the fiber material is oriented parallel to the tube axis. However, in alternative embodiments (not shown), the fiber material can be oriented non-parallel to the tube axis.

Tubular articles in accordance with the invention can be put to various uses, including use as winding cores, use as construction forms (e.g., forms for poured concrete), and use as structural members. The paperboard tube portion of the article can have a wall thickness ranging from about 0.075 inch to about 1.5 inches. In the case of winding cores, the inside diameter of the paperboard tube can range from about 1 inch to about 22 inches.

The outer shell can have a radial thickness ranging from as little as about 0.005 inch at the minimum thickness locations, up to as much as approximately 0.5 inch at the maximum thickness locations. In many applications, it will be advantageous for the circumferentially-averaged thickness of the shell to be less than the wall thickness of the paperboard tube, such that the paperboard tube comprises the majority of the total volume of the tubular article. For instance, the paperboard tube may constitute the primary structural member of the tubular article, and the outer shell may be provided mainly for the purpose of imparting a non-circular shape to the article. In other cases, the shell may constitute the majority of the total volume of the tubular article and may be the primary structural member, while the paperboard tube may function mainly as the substrate onto which the shell is pultruded; the paperboard tube may also be useful in providing a relatively soft, deformable surface at the inside of the tubular article (e.g., so that a winding chuck can readily grip the inside of the article, in the case of a winding core).

Other effects can be achieved in accordance with the invention. For example, by suitable selection of the resin composition, various surface textures and aesthetic effects can be created on the outer surface of the tubular articles of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A tubular article comprising:
a paperboard tube having an inner surface and an outer surface, the outer surface being circular in cross-section; and
a shell of resin pultruded onto the outer surface of the paperboard tube such that the shell is bonded to the outer surface of the paperboard tube, the shell having an inner surface of circular cross-section and an outer surface of non-circular cross-section.

2. The tubular article of claim 1, wherein the outer surface of the shell defines at least one longitudinally extending groove.

3. The tubular article of claim 1, wherein the outer surface of the shell defines a plurality of longitudinally extending grooves that are circumferentially spaced apart.

4. The tubular article of claim 3, further comprising a chemical deposited in the grooves for acting on a product wound about the tubular article.

5. The tubular article of claim 4, wherein the chemical comprises a desiccant.

6. The tubular article of claim 1, wherein the outer surface of the shell is polygonal in cross-section.

7. The tubular article of claim 1, wherein the outer surface of the shell is generally oval in cross-section.

8. The tubular article of claim 1, wherein the shell has a smaller average radial thickness than the paperboard tube.

9. The tubular article of claim 1, wherein the shell has a larger average radial thickness than the paperboard tube.

10. The tubular article of claim 1, wherein the paperboard tube comprises a plurality of paperboard plies helically wound about an axis one atop another and adhered together.

11. The tubular article of claim 1, wherein the paperboard tube has an inside diameter between about 1 inch and about 22 inches.

12. The tubular article of claim 11, wherein the paperboard tube has a radial thickness defined between the inner and outer surfaces thereof ranging from about 0.075 inch to about 1.5 inches.

13. The tubular article of claim 1, wherein the shell is reinforced with fiber material.

14. The tubular article of claim 13, wherein the fiber material is selected from the group consisting of glass fibers, aramid fibers, carbon fibers, and natural fibers.

15. A method for making a non-circular tubular article, comprising the steps of:
advancing a paperboard tube along a path parallel to a longitudinal axis of the tube, the paperboard tube having a circular outer surface; and
pultruding a shell of resin onto the outer surface of the advancing tube, the shell having an inner surface of circular cross-section bonded to the outer surface of the paperboard tube, the shell having an outer surface defining an outermost surface of the tubular article;
wherein the pultruding step comprises shaping the shell such that the outer surface of the shell has a non-circular cross-sectional shape.

16. The method of claim 15, wherein the pultruding step comprises the step of incorporating fiber material into the shell for reinforcing the shell.

17. The method of claim 16, wherein the step of incorporating fiber material comprises drawing fiber material from a creel and advancing the fiber material parallel to the longitudinal axis of the paperboard tube as the fiber material is incorporated into the shell.

18. The method of claim 15, wherein the shell is shaped to define a groove in the outer surface of the shell, the groove extending longitudinally along the tubular article.

19. The method of claim 18, wherein the shell is shaped to define a plurality of grooves extending longitudinally along the tubular article.

20. The method of claim 19, further comprising the step of depositing a chemical in the grooves.

21. The method of claim 15, wherein the shell is shaped such that the outer surface of the shell is polygonal in cross-section.

22. The method of claim 15, wherein the shell is shaped such that the outer surface of the shell is generally oval in cross-section.
